(19) United States
(12) Patent Application Publication
(10) Pub. No.: US 2003/0224649 A1
(43) Pub. Date: Dec. 4, 2003

(54) Protector for an overmolded connector

(76) Inventors: Fidel P. Vista JR., Las Pinas City (PH); Cesar Calma, Quezon City (PH); QingWen Liu, Baoan District Shenzhen City (CN)

Correspondence Address: HARNESS, DICKEY & PIERCE, P.L.C., P.O. BOX 828, BLOOMFIELD HILLS, MI, 48303, US

(21) Appl. No.: 10/157,374

(22) Filed: May 29, 2002

(51) Int. Cl. H01R 13/58

(52) U.S. Cl. 439/449

(57) ABSTRACT

An electrical connector assembly formed using an overmolding process. The electrical connector assembly includes a body which houses spring contacts, a spring mechanism, and terminals opposite to the spring contacts. The body is enclosed with a and protector which is defined by an upper portion and a lower portion. The upper and lower portions are cooperatively engaged to provide structural protection during the overmolding process and sealing protection as well.

### FIELD OF THE INVENTION

The present invention relates to connectors in general and, more particularly, to an overmolded connector assembly having a protector enclosing the connector for protection during the overmolding process.

### BACKGROUND OF THE INVENTION

There are numerous electronic, low-voltage devices which are commonly in use. Such devices typically need a supply of power for either charging an internal battery or for continuous operation. Power is typically supplied to the low voltage devices through electrical cords which are terminated with a connector. In many applications, the connectors are overmolded connectors. Overmolded connectors are characterized by a connector enclosed or encased within a shell. Such self-contained connectors are particularly attractive because they may be manufactured at a relatively low cost.

In a typical overmolded connector, one or a number of electrical terminals of the connector are soldered to a direct current (DC) cable. The solder joints are then typically covered by molding a small amount of resin over the solder joints. The premold material also serves as an initial layer to prevent molding defects when the overmold is applied. The soldered assembly is then overmolded with polyvinylchloride (PVC), which serves as the external enclosure for the connector assembly.

In a conventional overmold process, the overmolding process may warp the walls of the connector due the injection pressure. When the connector walls are pushed inward, they may interfere with the internal contact spring, inhibiting of free movement on the spring and possibly causing a malfunction of the connector. The deformation of the walls may also allow for some plastic resin to seep into the connector body and touch the spring terminals, causing the spring terminals to be further inhibited from moving freely.

Thus, there is a need for an overmolded connector which sufficiently protects the internal parts of the connector during the overmolding process.

### SUMMARY OF THE INVENTION

This invention is directed to a connector assembly including a connector. The assembly also includes an upper protector disposed above the connector and a lower protector disposed below the connector. The upper and lower protectors cooperate to seal the connector and structurally protect the connector. An overmolded portion of the connector assembly encases the protector, and the overmolded portion is sealed from the connector by the upper and lower protectors.

This invention is also directed to a method of forming a connector assembly comprising the steps of providing a connector and enclosing the connector within a protective shell defined by an upper portion and a lower portion. The upper and lower portions are arranged to protect and seal the connector. Next the connector and protective shell are overmolded. The protective shell protects the connector from mechanical deformation during the overmolding process and seals the connector during the overmolding process

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts an assembled view of an overmolded connector arranged in accordance with the principles of the present invention;

FIG. 2 depicts an exploded view of the overmolded connector assembly of the present invention;

FIG. 3 depicts a longitudinal cross-sectional view of the overmolded connector assembly of the present invention; and

FIG. 3 is a partial cut away view of the overmolded connector assembly of the present invention.

### DETAILED DESCRIPTION OF THE PREFERRED EMBODIMENTS

The following description of the preferred embodiment(s) is merely exemplary in nature and is in no way intended to limit the invention, its application, or uses.

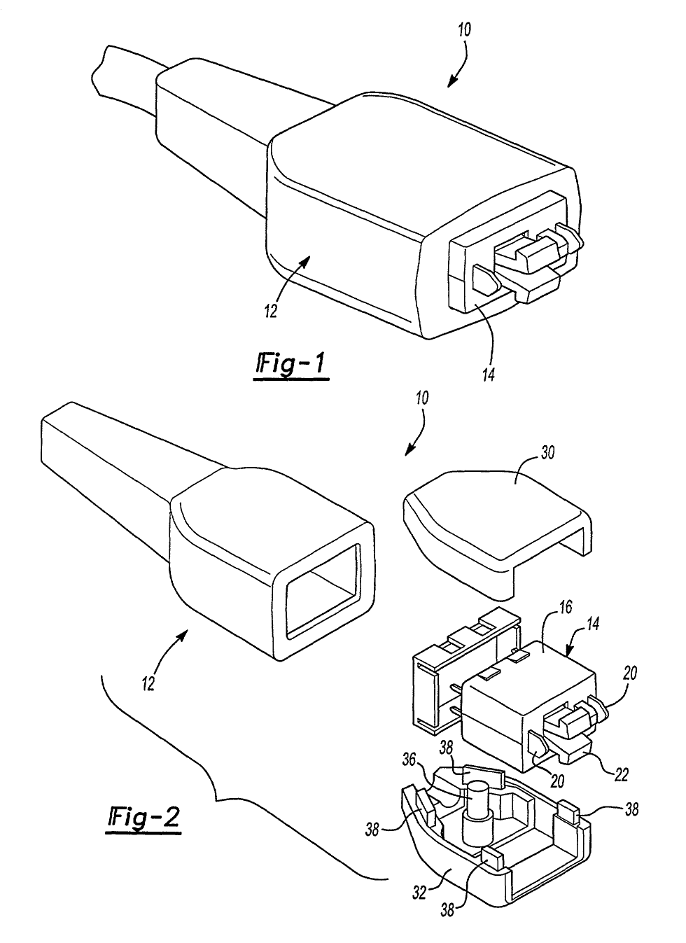

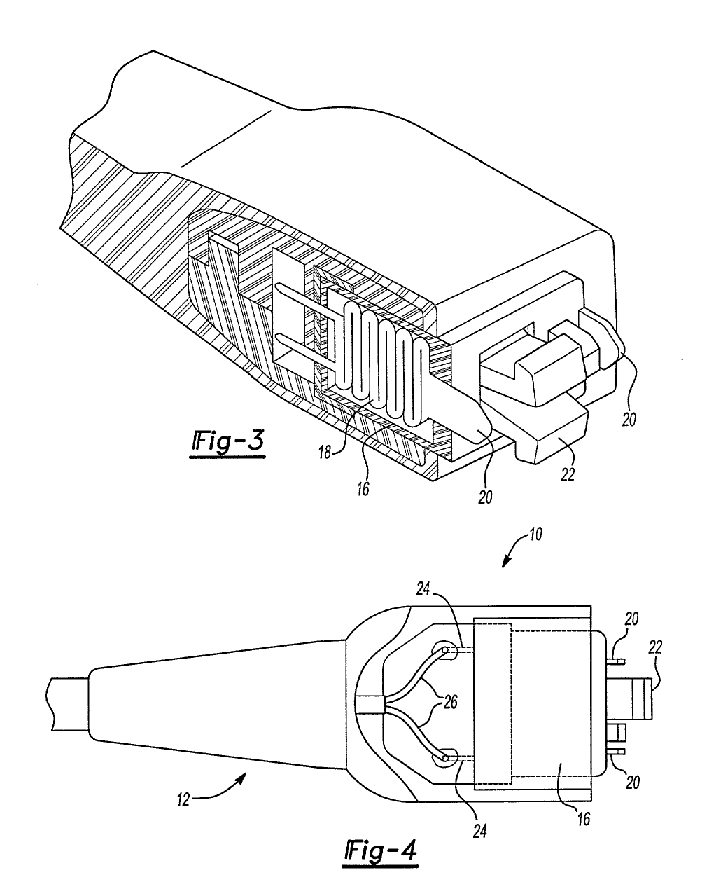

With reference to FIGS. 1-4, FIG. 1-4 depict various views of the overmolded connector assembly 10 of the present invention. Connector assembly 10 includes an overmolded portion 12 which encases a connector 14, such as a DC connector. It will be understood by those skilled in the art, however, that the connector 14 of connector assembly 10 may be any of a number of connectors other than DC connectors.

Connector 14 includes a housing 16, which is typically formed of plastic, but may be formed of other suitable materials. Housing 16 encloses electrically conductive springs 18 which terminate at spring contacts 20. Housing 16 also typically is formed to include an integral retainer 22 which engages a mating connector (not shown). As best seen in FIG. 4, springs 18 includes a second pair of terminals 24 opposite that of spring contacts 20.

An upper protector 30 encases housing 16 on an upper side of housing 16. Similarly, a lower protector 32 encases housing 16 on a lower side of housing 16. Protectors 30 and 32 cooperate to protect housing 16 as well as contacts 24. In particular, connectors 30 and 32 are matingly sized and engaged to prevent an inflow of resin during the overmolding process. Further, protectors 30 and 32 are suitably formed and engaged so as to provide structural protection for housing 16. Thus, during the overmolding process, the injection pressure exerted upon upper protector 30 and lower protector 32 does not deform protectors 30, 32, rather than being absorbed by housing 16 cannot thereby leading to be possible deformation.

As described above, protectors 30 and 32 are formed so as to be engaged to protect housing 16. As can be at best be seen in FIG. 2, protector 32 includes a projection 36 which engages a correspondingly formed female counterpart (not shown) of upper protector 30. A plurality of tabs 38 formed in lower protector 30 to cooperate to engage upper protector 30 in order to maintain engagement between upper protector 30 and lower protector 32.

In order to manufacture connector assembly 10, wires 26 are soldered to terminals 24 of connector 16. The connector is then enclosed by upper protector 30 and lower protector 32, which are engaged as described above in order to maintain a structural and injection mold resistant seal. The protector and connector subassembly are then placed in an injection molding. Overmolded portion 12 is then formed by injection molding.

The connector assembly 10 described herein and provides several benefits and advantages over the prior art. In particular, upper protector 30 and lower protector 32 cooperate to provide both a structural seal to protect housing 16 during the overmolding process. In addition to structural support provided by upper protector 30 and lower protector 32, the protectors 30, 32 cooperate to provide a fluid seal during the overmolding process in order to protect the solder joints 24 which interconnect wires 26 and terminals 24.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A connector assembly, comprising:
a connector;
an upper protector disposed above the connector;
a lower protector disposed below the connector, wherein the upper and lower protectors cooperate to seal the connector and structurally protect the connector; and
an overmolded portion, the overmolded portion encasing the protector,
wherein the overmolded portion is sealed from the connector by the upper and lower protectors.

2. The connector assembly of claim 1 wherein the protector is formed of plastic.

3. The connector assembly of claim 1 wherein the connector includes a solder joint, and the solder joint is protected by the upper and lower protectors.

4. The connector assembly of claim 3 wherein the protector is formed of plastic.

5. The connector assembly of claim 1 wherein one of the upper and lower protectors includes a guide member for aligning the upper and lower protectors, and the other of the upper and lower protectors is formed to receive the guide member.

6. The connector assembly of claim 1 wherein one of the upper and lower protectors includes a locking member to maintain engagement between the upper and lower protectors, and the other of the upper and lower protectors is formed to receive the locking member.

7. The connector assembly of claim 6 wherein one of the upper and lower protectors includes a guide member for aligning the upper and lower protectors, and the other of the upper and lower protectors is formed to receive the guide member.

8. A method of forming a connector assembly comprising the steps of:
providing a connector;
enclosing the connector within a protective shell defined by an upper portion and a lower portion, wherein the upper and lower portions are arranged to protect and seal the connector;
overmolding the connector and protective shell, wherein the protective shell protects the connector from mechanical deformation during the overmolding process and seal the connector during the overmolding process.

9. The method of claim 8 wherein the protector shell is formed of plastic.

10. The method of claim 9 wherein the connector includes a solder joint and wherein the solder joint is environmentally protected by the protective shell.
